(19) United States
(12) Patent Application Publication
(10) Pub. No.: US 2016/0119692 A1
(43) Pub. Date: Apr. 28, 2016

(54) INTERACTIVE SYSTEM AND METHOD FOR VIEWER SELECTION OF OBJECTS IN CONTEXT WHILE VIEWING TELEVISION

(71) Applicant: Sunshine Partners LLC, Concord, MA (US)

(72) Inventors: Priti H. CHATTER, Concord, MA (US); Sonal CHATTER, Concord, MA (US)

(21) Appl. No.: 14/922,140

(22) Filed: Oct. 24, 2015

Related U.S. Application Data
(60) Provisional application No. 62/068,269, filed on Oct. 24, 2014.

(51) Int. Cl. H04N 21/84; H04N 21/41; H04N 21/2665

(52) U.S. Cl. CPC H04N 21/84; H04N 21/2665; H04N 21/4104

(57) ABSTRACT

Systems and methods are disclosed that enable a viewer to select one or more objects in frames of interest in a television program while viewing the television program, in order to receive additional information about the selected object.

### BACKGROUND OF THE INVENTION

1. Field Of The Invention

The present disclosure relates generally to interactive television, more specifically to obtaining additional information about an imaged object that is selected by a viewer.

2. Description Of The Background

As an example consider a television show demonstrating a new surgical procedure. If an average viewer of this show is interested in learning more about the procedure, its success rate, specifics about the type of patients eligible for such surgery, or about the hospitals that provide such surgery, he or she does not have much choice except to independently search internet and spend time to extract that information. If the viewer is a medical expert such as a doctor and is interested in learning more about this type of surgery, surgical training opportunities, or about the equipment used during the surgery then it is the same issue as above, the doctor has to independently access internet, spend cycles searching for this type of surgical training and the equipment used. In either of the situation, the viewer does not have an ability to interact with the show to quickly get the desired information delivered.

Another example is that of a viewer watching a television show about astronomy. The viewer is interested in learning more about a galaxy and/or a specific star that is part of the galaxy shown during the show. Unfortunately, the viewer does not have much choice, he or she has to search internet and try to find more information about that specific object of interest.

To address the above constraints the following innovative solution is proposed.

### SUMMARY OF THE INVENTION

Systems and methods are disclosed that enable a viewer to select one or more objects of interest in context, i.e., in video frames of a television program, while viewing television, in order to receive additional information about the selected object.

A system is disclosed that comprises a controller; a television having a television screen that is operatively connected to the controller; a user input device that is operatively connected to the controller; wherein at least one of the controller, the television, or the user input device is operatively connected via a network to a server computer that can access a database on a storage device; and a recipient device selected from a smart phone, a tablet computer, a phablet, laptop computer, a desktop computer, wherein the recipient device is operatively connected via a network to the server computer; wherein the user interface device is capable of indicating a video image comprising at least a portion of one video frame and wherein the user interface device can accept user input to allow the user to select a portion of the video image; and wherein selection of portion of the video frame is effective to cause the server computer to retrieve information relevant to the selected portion of the video frame from the database and communicate the information relevant to the selected portion of the video frame to the recipient device.

In certain embodiments, the user input device is a smart phone, a tablet computer, a phablet, laptop computer, a desktop computer, a remote or a frame/object selector hardware device. In certain embodiments, the controller is the set top box for a cable television system or a satellite television system.

In certain embodiments, the network comprises at least one of a local area network (LAN), a wide area network (WAN), a cellular network or the Internet. In preferred embodiments, the network is the Internet.

In preferred embodiments, the system can correlate user input with a position on the image displayed on the television screen to identify an object within the image. In preferred embodiments, the identified object is associated in a database with information, or links to information that is relevant to the object.

In other embodiments, a method is disclosed comprising the steps of displaying a video frame on the television screen of the disclosed system; accepting user input data related to a position on the video frame from a user input device; communicating the user input data related to a position on the video frame to a server computer; correlating the user input data related to a position on the video frame with an object imaged in the video frame to identify the imaged object; retrieving information relevant to the imaged object from a database; and communicating the information relevant to the imaged object to a recipient device. Typically, method includes the step of communicating an image of the object to the recipient device.

The above described and other features are exemplified by the following figures and detailed description.

### BRIEF DESCRIPTION OF THE DRAWINGS

The foregoing and other features and advantages will be apparent from the following more particular description of exemplary embodiments of the disclosure, as illustrated in the accompanying drawings, in which like reference characters refer to the same parts throughout the different views. The drawings are not necessarily to scale, emphasis instead being placed upon illustrating the principles of the disclosure.

FIG. 1 is a diagram of an embodiment, showing a system 100 including a television 120 operatively connected to a controller box 130, a smart device 140 operatively connected to a controller box 130, and a remote control 150 operatively connected to a controller box 130, wherein the system 100 is available for interaction with a viewer 160, and wherein the system 100 is operatively connected through a network 170 to one or more servers 180 and databases 190.

FIG. 2 is a diagram of an embodiment, showing a system 100 including a television 120, operatively connected to a controller box 130, a smart device 140 operatively connected to a controller box 130, a Frame/Object Selector Hardware Device (FOSHD) 145 operatively connected to a controller box 130, and a remote control 150 operatively connected to a controller box 130, wherein the system 100 is available for interaction with a viewer 160, and wherein the system 100 is operatively connected through one or more networks 170 to one or more servers 180 and databases 190.

### DETAILED DESCRIPTION OF PREFERRED EMBODIMENTS

Definitions. As used herein, the term “program” is used generically; and can refer to a onetime program or could consist of several episodes and so on.

As used herein, the singular includes the plural. Thus “recipient device” includes “at least one recipient device,” “one or more recipient devices,” and “several recipient devices.” Similarly, “server” includes “at least one server,” “one or more servers,” and “several servers.”

As used herein, “smart device” refers to a smart phone, a tablet computer, a phablet, laptop computer, a desktop computer or other devices with a wireless or wireline connection to the Internet. In preferred embodiments the smart device has a touch screen user interface. A phablet is a mobile device designed to combine or straddle the functions of a smartphone and tablet. The smart device can be used by the viewer for one or more tasks such as to interact with the controller, and/or to send or receive information through the Internet. In certain embodiments, the system can include more than one smart device, since there may be more than one viewer, each viewer having at least one smart device.

As used herein, “FOSA” refers to a frame/object selection application. As used herein, “FOSHD” refers to a frame/object selector hardware device. As used herein, “SII” refers to Selected Image Information.

As used herein, “remote” refers to a remote control adapted to communicate with and control a television set or a controller.

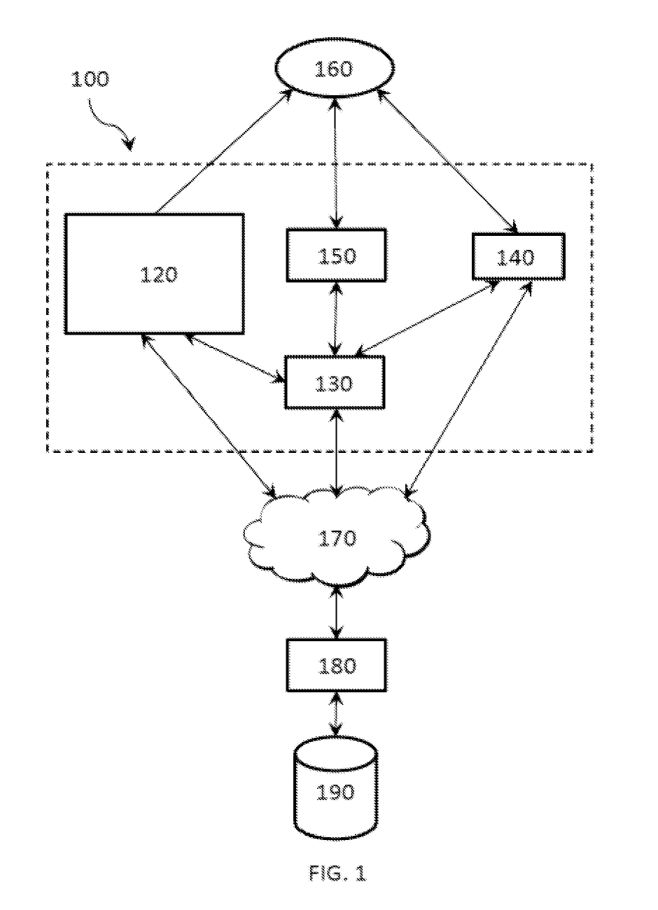

A typical viewing set up is shown in FIG. 1. FIG. 1 is a diagram of an embodiment, showing a system 100 including a television 120, operatively connected to a controller box 130, a smart device 140 operatively connected to a controller box 130, and a remote control 150 operatively connected to a controller box 130, wherein the system 100 is available for interaction with a viewer 160, and wherein the system 100 is operatively connected through a network 170 to one or more servers 180 and databases 190. In certain embodiments, the network 170 comprises the Internet.

In certain embodiments, the television 120 is a smart television with operative connectivity to the Internet 170. In certain other embodiments, the television 120 is a conventional television. In other embodiments, the television 120 is a smart television, but its Internet connectivity is not active.

The television 120 in system 100 is controlled by a controller 130. In certain embodiments, the controller 130 can be a cable box, a satellite box, or another type of controller independent of the mechanism of content delivery, such as cable, satellite, fiber optic cable, wirelessly. In certain embodiments, the controller 130 can have Internet connectivity via physical interfaces such as a telephone line or an Ethernet jack or via wireless network such as Wi-Fi or a phone company's wireless network. In certain embodiments, the controller 130 can have one way or bi-directional communication with smart devices 140. Typically, the controller 130 has the information about what is being watched, the episode number if any, the frame ID (“identification”), the frame format, and other relevant data.

In some embodiments, the viewer 160 generally uses a remote 150 to signal the controller 130 (also known as a “set-top box” or STB) to select a program. In certain embodiments, the function of the remote 150 can be provided by an application running on a smart device 140 that provides direct bidirectional communication with the controller 130. One of ordinary skill will recognize that there are numerous possible system configurations depending on the capabilities and features provided by each component in the system.

Several embodiments of system configurations are described below. The process of a viewer 160 selecting the image of at least one object in the context of at least one frame of a video program is disclosed. Such a process can be repeated at any time during the video program. The approach can be used if the video program being watched is live, being played back from a DVR, or another device with the necessary storage and buffering capabilities.

The following non-limiting examples further illustrate various embodiments.

### WORKING EXAMPLES

### Example 1

In a certain embodiment, the system 100 comprises a smart television 120, a corresponding controller 130 that can communicate bi-directionally with the viewer's at least one smart device. The controller 130 is operatively connected to the Internet 170 directly or via the smart television 120. An application called FOSA (Frame/Object Selection Application) on the smart device 140 provides interaction with the controller 130. The FOSA is typically activated by the viewer 160. The smart device 140 running FOSA is automatically recognized by the controller 130 once registration has been completed. During registration, the FOSA may ask for the identity of the device that will receive the requested information, such as the smart device 140 itself, or another suitable device, including, but not limited to, a tablet computer, a phablet, laptop computer, or desktop computer. If no such information is provided, or registration is not done, then the automatic default destination of the requested information is the smart device 140. The requested information could be delivered by email, text, or other available means of access to network 170.

As an example, consider a viewer 160 watching an instructional television program demonstrating a new surgical procedure. The television program may be directed to an average viewer interested in learning more about the procedure, its success rate, specifics about the type of patients eligible for such surgery, or about the hospitals that provide such surgery. Other viewers may be health care professionals, such as surgeons, who may have a more detailed and professional interest in the program. With the currently available technology, whether the viewer 160 is a health care professional or an average viewer, if more information is desired, the viewer 160 must independently search the Internet 170 and spend time to extract that information. Even if the viewer 160 is a health care professional, such as a surgeon who is interested in learning more about this type of surgery, surgical training opportunities, or about the equipment used during the surgery, the same procedure is required. The surgeon would have to independently access the Internet 170, and go through several iterations of searching for this type of surgical training and the equipment used. Whether the viewer 160 is a health care professional or an average viewer, the viewer 160 does not have an ability to interact through the video program in real time to have the desired information delivered quickly.

In certain embodiments of the present disclosure, a viewer 160 who is interested in learning more about the equipment used during the surgical procedure can move a cursor that is provided by the FOSA by using the touchscreen of the smart device 140. As the cursor is moved on the smart device touchscreen, the relevant movement data such as the amount of movement and the direction are communicated to the controller 130. The controller 130 scales the communicated relevant movement data to produce a corresponding movement of an indicator on the television screen, thus providing real time feedback to the viewer 160. Once the cursor movement caused by the viewer using the smart device 140 touchscreen results in a corresponding movement of the indicator on the image of the item of interest on the television 120 screen, the viewer selects the object by the FOSA transmitting a select command. Upon receipt, this select command is processed by the controller 130, and metadata such as the coordinates of the selected image in the television frame and other metadata such as the Selected Image Information, are communicated between the controller 130 and the relevant server 180 though the Internet 170. In one embodiment, the server 180 and an associated database 190 can have a matrix for a given frame format that uniquely identifies an object in a given frame by its coordinates in a frame. Subsequently, the server 180 sends the information about the object in the selected image, surgical equipment in this example, via the Internet 170 to one or more recipient devices that were designated by the requesting smart device 140. The information could include, but is not limited to, information about the objects corresponding to the selected image, such as overview, details, specifications, availability, etc.

In another embodiment, the frames may have been pre-processed and objects uniquely identified, and the controller 130 itself can have the unique ID for the object selected in a frame and can provide that to the server 180 as part of the Selected Image Information. There are easily other variations on the same theme, but the essential idea is to uniquely identify the object. In an alternative embodiment, the Selected Image Information including the coordinates of the selected object is provided to the FOSA on the requesting smart device 140. The FOSA then communicates the Selected Image Information via the Internet 170 to an appropriate server 180. In return, the server 180 communicates the information about the selected equipment to the designated recipient device via the Internet 170. In either embodiment, given that a viewer profile could generally be identified through a controller 130, further narrowed by a smart device 140, and her intent has been expressed, the information provided can be highly personalized to the viewer 160. In this example in which the viewer 160 is a health care professional, links to professional publications, and/or detailed technical specifications in addition to the generic information related to the selected equipment could be sent to the designated recipient device.

### Example 2

In this Example, a viewer 160 is watching an astronomy program on television 120. During the program, a particular type of galaxy is shown with unique characteristics. This galaxy has piqued the viewer's interest, and the viewer is keen on learning more about it. She then taps (or performs an equivalent action) on the touchscreen of a smart device 140 that is running FOSA. Immediately this request for information, with its time stamp, is sent to the controller 130. The controller 130 matches this time stamp to the corresponding frame in the program being watched, i.e., the frame that includes the image of the galaxy.

There can be at least two options available at this point. In a first embodiment, the relevant information such as the program name, episode number, frame number, requesting smart device info etc., all generically referred as “Selected Image Information” or SII, are communicated by the controller 130 through the Internet 170 to the appropriate server 180. The server 180 queries a database 190, then sends the requested frame, accompanied by relevant information, such as the information is about the frame and/or about one or more objects in the frame and/or the background, etc. to the recipient device that has been designated by the requesting smart device 140.

In an alternative embodiment, the SII is provided to the FOSA running on the requesting smart device 140 that then communicates the SII to the appropriate server 180 via the Internet 170. In return, the designated recipient device receives the requested frame along with relevant information, in this example, about the galaxy from the server 180 via the Internet 170. One of the key differences between these two approaches is which data bandwidth is consumed for the underlying task—that of the controller 130 or that of the viewer's smart device 140. Another driving factor is that the server 180 connected to the database 190 that contain the desired information may be only accessible via the Internet 170 by the controller 130 or by the smart device 140, but not by both. In either event, given that smart device 140 is recognized, the accompanied data that is sent from the server 180 along with the frame can be personalized to the viewer. For example, if a viewer 160 is an average person, then high level information is provided. On the other hand, if the viewer 160 is an expert in the field, such as a professional astronomer, relevant links to the articles published in scientific journals can be provided.

### Example 3

In this Example, the viewer 130 has a conventional television 120 instead of a smart television and the corresponding controller 130 has the ability to carry bi-directional communication with viewer's one or more smart devices 140, and controller 130 is also operatively connected to the Internet 170 directly—wireless or wireline.

In this embodiment, the process will be similar to as described in Example 1, above, except that any communication between the controller 130 and the server 180 is direct via the Internet 170, instead of via a smart television.

### Example 4

In this Example, a viewer 160 is watching a program on a conventional television 120, the corresponding controller 130 is in bi-directional communication with the viewer's one or more smart devices 140, but the controller 130 is not operatively connected to the Internet 170.

As in Example 2, above, the viewer is watching an astronomy program. During the program a particular type of galaxy is shown with unique characteristics. The said galaxy has piqued the viewer's interest quite a bit and she is keen on learning more about it. She then taps (or performs an equivalent action) on the touchscreen of the smart device 140 that is running FOSA. Immediately this request for information, with its time stamp, is sent to the controller 130. The controller 130 matches this time stamp to the corresponding frame in the program being watched, i.e., the frame that includes the image of the galaxy. The Selected Image Information is provided to the FOSA running on the requesting smart device 140, which then communicates the Selected Image Information via the Internet 170 to the appropriate server 180. In response, designated recipient device receives the requested frame along with relevant information, for example in this case about the galaxy, from the server 180 via the Internet 170.

In another embodiment, the viewer 160 is watching a television program about a new surgical procedure as in Example 1, above. The viewer 160, a doctor who is interested in learning more about the equipment used during the surgical procedure that is shown. While watching, she moves a cursor on the screen of the smart device 140 that is running FOSA. As the cursor is moved, the relevant data such as the amount of movement and the direction are communicated by FOSA with an instruction from the smart device 140 to the controller 130. The controller 130 subsequently processes the instruction and information and moves a corresponding indicator on the television screen, thus providing a real time feedback to the viewer 160. Once the cursor movement by the viewer 160 on the smart device screen positions the indicator on the television screen on the equipment of interest, the viewer selects the object using FOSA, which sends a selection command to the controller 130. Upon receipt, the controller 130 processes the selection command, and the coordinates of the selected object on the television frame, along with rest of the Selected Image Information, are provided by the controller 130 to FOSA running on the smart device 140. The smart device 140 then communicates the coordinates of the selected object on the television frame, along with rest of the Selected Image Information to the appropriate server 180 via the Internet 170.

For embodiments in which the television 120 is a smart television instead of conventional television, the controller 130 can communicate with server 180 via the Internet 170 using the smart television's Internet connectivity and the process would be similar to that described in Example 1.

### Example 5

In this Example, the viewer 160 is watching a program on a conventional television 120, the controller 130 that is operatively connected to the television 120 is operatively connected to the smart device 140 only to receive commands, and cannot respond back to the smart device 140. The controller 130 is operatively connected to the Internet 170.

As in Example 2, a viewer is watching an astronomy program. During the program a particular type of galaxy is shown with unique characteristics. The galaxy has piqued the viewer's interest quite a bit and she is keen on learning more about it. She then taps (or equivalent action) on the touchscreen of the smart device 140 that is running FOSA. Immediately this request for information, with its time stamp, is communicated by the smart device 140 to the controller 130. The controller 130 matches this time stamp to the corresponding frame in the program being watched, and the Selected Image Information is communicated via the Internet 170 to the appropriate server 180 and in return the designated recipient device receives the requested frame along with relevant information retrieved from database 190.

As in Example 1, a viewer 160, a doctor, is watching a television program about a new surgical procedure, and is interested in learning more about the equipment used during the surgical procedure. While watching, she moves a cursor displayed by FOSA on the touchscreen of the smart device 140. As the cursor is moved on the smart device screen, the relevant movement data such as the amount of movement and the direction are communicated by the smart device 140 to the controller 130. The controller 130 processes the instruction and data received and correspondingly moves a indicator on the television screen, thus providing a real time feedback to the viewer 160. Using the touch screen on the smart device 140, the viewer 160 moves the corresponding indicator on the television screen to select the object of interest, the surgical equipment, and FOSA communicates a select command to the controller 130. Upon receipt, this select command is processed by the controller 130, and the coordinates of the selected object on the television frame along with rest of the Selected Image Information are communicated by the controller 130 via the Internet 170 to the appropriate server 180. The server 180 retrieves the information about the surgical equipment from database 190 and communicates the retrieved information via the Internet 170 to the recipient devices designated by the requesting smart device 140.

In embodiments in which the television 120 is a smart television instead of a conventional television, the controller 130 can communicate with server 180 using the smart television's Internet connectivity and would not be required to have its own Internet connectivity; the rest of the process would be as described above.

### Example 6

The television 120 is a conventional television or a smart television; the controller 130 is conventional and communicate with the smart device 140. The controller 130 has direct or indirect Internet connectivity through the television 120.

In an embodiment, the viewer 160 uses the remote 150 to enter the name of the program and, if needed, the episode number. The viewer 160 also enters the name of the program and, if needed, the episode number in FOSA on the smart device 140.

As in Example 2, above, the viewer 160 is watching an astronomy program. During the program a particular type of galaxy is shown with unique characteristics. The galaxy has piqued the viewer's interest quite a bit and she is keen on learning more about it. She stores an image of the frame of interest. Subsequently, the image is communicated by the smart device 140 via the Internet 170 to the appropriate server 180. At the server 180, the image is matched with the corresponding frame of the program and subsequently the designated recipient device receives the requested frame along with relevant information, in this example, about the galaxy.

As in Example 1, in which the viewer 160 is watching a television program about a new surgical procedure. The viewer, a doctor is interested in learning more about the equipment used during the surgical procedure. She stores an image of the frame of interest using the smart device 140. She then selects the desired object in this image of the frame on her smart device 140 under the control of FOSA. The object is virtually marked on the image. (It should be noted that viewer can select more than one object if so desired). Subsequently, this marked image is communicated by the smart device 140 via the Internet 170 to the appropriate server 180. At the server 180, the image is matched with the corresponding frame of the program and the marked object (in this example the surgical equipment) is identified. Then the relevant information about that selected surgical equipment is retrieved from database 190 and communicated by the server via the Internet to the designated recipient device.

In a preferred embodiment, at production or subsequently, an optical code is embedded to the frames of the video program. A preferred location is likely at a bottom corner of a frame, although the location could be anywhere in the frame. The optical code contains the relevant data such as program name, the episode number if any, frame ID, etc.

As in Example 2, a viewer 160 is watching an astronomy program. During the program a particular type of galaxy is shown with unique characteristics. The said galaxy has piqued the viewer's interest quite a bit and she is keen on learning more about it. She stores an image of the frame of interest using the smart device 140.

In one embodiment, the smart device 140 has optical decoding capability wherein the encoded information is extracted and then the extracted information along with rest of the Selected Image Information is sent by the smart device 140 via the Internet 170 to the appropriate server 180.

In another embodiment, an external optical decoder is used to decode the code and communicates the code to the smart device 140, for example, through a LAN or a Bluetooth connection, and then the extracted information along with rest of the Selected Image Information is sent by the smart device 140 via the Internet 170 to the appropriate server 180.

In a further embodiment, the image that contains the optical code is sent by the smart device 140 via the Internet 170 to the appropriate server 180 “as is” for further extraction and decoding there. Then the relevant information about that frame is retrieved from database 190 and communicated by the server via the Internet to the designated recipient device.

Continuing with Example 1 in which a viewer is watching a television program about a new surgical procedure. The viewer, a doctor is interested in learning more about the equipment used during the surgical procedure. She stores an image of the frame of interest using the smart device 140. Then the viewer 160 selects the desired object in this frame on the smart device 140 using FOSA. The object is virtually marked on the image.

In one embodiment, the smart device 140 has optical decoding capability wherein the encoded information is extracted and then the extracted information along with rest of the Selected Image Information is sent by the smart device 140 via the Internet 170 to the appropriate server 180.

In another embodiment, an external optical decoder is used to decode the code and communicates the code to the smart device 140, for example, through a LAN or a Bluetooth connection, and then the extracted information along with rest of the Selected Image Information is sent by the smart device 140 via the Internet 170 to the appropriate server 180.

In a further embodiment, the image that contains the optical code is sent by the smart device 140 via the Internet 170 to the appropriate server 180 “as is” for further extraction and decoding there. At server 180 the object is quickly identified with the help of the information provided. Then the relevant information about that selected object, in this example the surgical equipment, is retrieved from database 190 and communicated by the server 180 via the Internet 170 to the designated recipient device.

An alternative that works for both the frame selection and the object selection is to have the optical code be selectable by the remote control 150. In this scenario, the viewer 160 is not required to store an image using the smart device 140. Instead, the selected frame is sent from the controller 130 via the Internet 170 to the appropriate server 180 and communicated by the server 180 via the Internet to the smart device 140. For object selection, the frame received by the smart device 140 can be can be marked-up using FOSA for selection of the desired object, and communicated via the Internet 170 to the appropriate server 180. At the server 180, the desired object is identified, the relevant information is retrieved from database 190 and the retrieved information relevant to the selected object is communicated by server 180 via the Internet 170 to the smart device 140.

### Example 7

The television 120 is a conventional television or a smart television; the controller 130 has direct or indirect Internet connectivity through the television 120. No smart device 140 is nearby, as either the smart device 140 is not co-located with the viewer 160, or the wireless reception in the viewing room is poor, or may be the viewer just does not want to be bothered using a smart device 140 while watching a program etc.

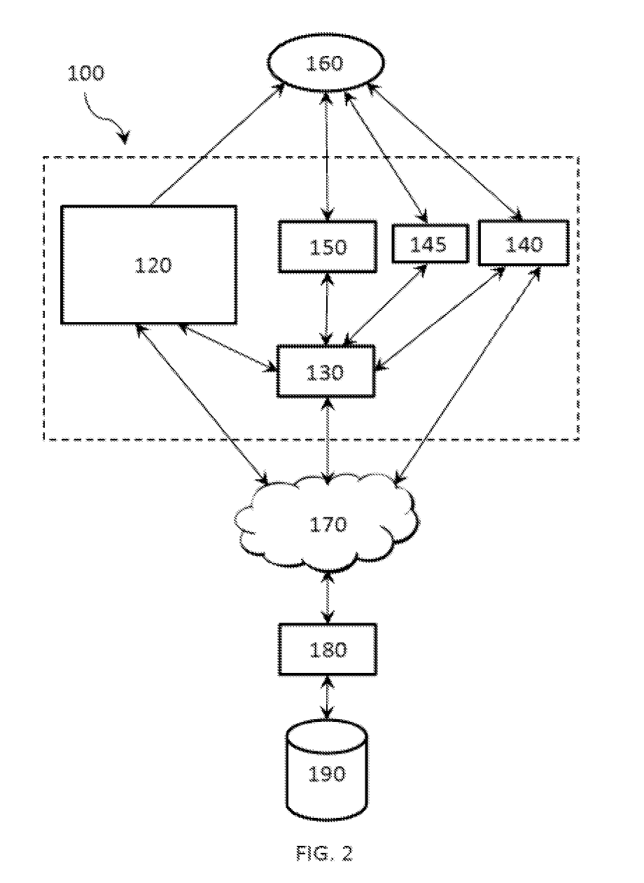

In this case a custom hardware device named Frame/Object Selector Hardware Device (FOSHD) 145 is used as shown in FIG. 2. This device can move a cursor and transmit commands in the format expected by the controller 130. In such embodiments, the controller 130 also has the ability to process the commands from the FOSHD 145.

As in Example 2, a viewer 160 is watching an astronomy program. During the program a particular type of galaxy is shown with unique characteristics. The said galaxy has piqued the viewer's interest quite a bit and she is keen on learning more about it. She then clicks on the select button on the FOSHD 145. Immediately that select command with its time stamp is sent to the controller 130. The controller 130 matches that time stamp to the corresponding frame in the program being watched. The Selected Image Information is communicated by the controller 130 via the Internet 170 to the appropriate server 180. At the server 180 the selected object, a galaxy, is identified, the relevant information about that selected object is retrieved from database 190 and communicated by the server 180 via the Internet 170 to the designated recipient device.

Continuing with the example in which a viewer 160 is watching a television program about a new surgical procedure. The viewer, a doctor is interested in learning more about the equipment used during the surgical procedure. While watching, she moves a tracker on the FOSHD 145 in a direction that will move an indicator on the television screen closer to the desired object. As the FOSHD tracker moves, the relevant movement data such as the amount of movement and the direction are communicated by the FOSHD 145 to the controller 130. The controller 130 processes the received instruction and correspondingly moves an indicator on the television screen, thus providing real time feedback to the viewer 160, and the viewer selects the object using the FOSHD 145. The select command with its time stamp is sent to the controller 130. Upon receipt, this select command is processed by the controller 130, and the coordinates of this selected object on the television frame along with rest of the Selected Image Information are provided by the controller 130 via the Internet 170 to the appropriate server 180. At the server 180 the selected object is identified, the relevant information about that selected object is retrieved from database 190 and communicated by the server 180 via the Internet 170 to the designated recipient device. In an alternative embodiment, the FOSHD functionality could be incorporated in a remote.

### Example 8

The viewer 160 has a conventional television or a smart television; the operatively connected controller 130 is conventional and does not work with a smart device 140. However, smart device 140 is available to the viewer 160.

The viewer 160 enters the name of the television program, and in some cases the episode number as well, in a FOSA running on the smart device 140. The FOSA enables continuous recording of audio for a short duration. When the viewer 160 is interested in a frame, she taps on her smart device screen. The time stamp along with the audio snippet is then sent by the smart device 140 via the Internet 170 to an appropriate server 180. At the server 180 the audio snippet is used to identify the frame with reasonable accuracy, and the frame and relevant information is retrieved from a database 190. In case where the viewer is only interested in a frame, such frame and the relevant information is communicated by server 180 via the Internet 170 to the designated recipient device.

In embodiments in which one or more objects are of interest to the viewer, the following method can be used. Continuing with the example in which a viewer is watching a television program about a new surgical procedure. The viewer, a doctor is interested in learning more about the equipment used during the surgical procedure. She stores an image of the frame of interest using the smart device 140. The viewer selects the desired object in the image of this frame on its smart device 140 under FOSA. The object is virtually marked on the image and the smart device 140 communicates the marked image via the Internet 170 to an appropriate server 180. At the server 180, the image only need be compared against a very few frames as opposed to the entire program's worth and the marked object is identified. Relevant information about the identified object is retrieved from database 190 and communicated by server 180 via the Internet 170 to the designated recipient device.

In summary, several cases have been described above, however, there are many more additional variations and combinations and are considered within the scope of this application. Furthermore, it should be noted that while surgery and astronomy programs have been used as examples, the same approach could also be applied to other types of programs, programs etc.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A system comprising
a controller;
a television having a television screen that is operatively connected to a controller;
a user input device operatively connected to the controller;
wherein at least one of the controller, the television, or the user input device is operatively connected via a network to a server computer that can access a database on a storage device; and
a recipient device selected from a smart phone, a tablet computer, a phablet, laptop computer, a desktop computer, wherein the recipient device is operatively connected via a network to the server computer;
wherein the user interface device is capable of indicating a video image comprising at least a portion of one video frame and wherein the user interface device can accept user input to allow the user to select a portion of the video image; and
wherein selection of portion of the video frame is effective to cause the server computer to retrieve information relevant to the selected portion of the video frame from the database and communicate the information relevant to the selected portion of the video frame to the recipient device.

2. The system of claim 1 wherein the user input device is a smart phone, a tablet computer, a phablet, laptop computer, a desktop computer, a remote or a frame/object selector hardware device.

3. The system of claim 1 wherein the controller is the set top box for a cable television system or a satellite television system.

4. The system of claim 1 wherein the network comprises at least one of a local area network (LAN), a wide area network (WAN), a cellular network or the Internet.

5. The system of claim 1 wherein the system can correlate user input with a position on the image displayed on the television screen to identify an object within the image.

6. The system of claim 5 wherein the object is associated in a database with information, or links to information that is relevant to the object.

7. A method comprising the steps of
displaying a video frame on the television screen of the system of claim 1;
accepting user input data related to a position on the video frame from a user input device;
communicating the user input data related to a position on the video frame to a server computer;
correlating the user input data related to a position on the video frame with an object imaged in the video frame to identify the imaged object;
retrieving information relevant to the imaged object from a database; and
communicating the information relevant to the imaged object to a recipient device.

8. The method of claim 7 further comprising the step of communicating an image of the object to the recipient device.
